(19) United States
(12) Patent Application Publication
(10) Pub. No.: US 2008/0127443 A1
(43) Pub. Date: Jun. 5, 2008

(54) Paint tray

(76) Inventor: Normand Blanchard, Gatineau (CA)

Correspondence Address: GEORGE A. SEABY;SEABY & ASSOCIATES, 250 CITY CENTRE AVNUE, OTTAWA, ON, K1R6K7, omitted

(21) Appl. No.: 11/987,604

(22) Filed: Dec. 3, 2007

Related U.S. Application Data
(60) Provisional application No. 60/872,491, filed on Dec. 4, 2006.

(51) Int. Cl. B44D 3/12

(52) U.S. Cl. 15/257.06

(57) ABSTRACT

A conventional paint tray having a well at one end thereof is provided with a ledge on the well end of the tray so that the handle of a roller and/or a brush can be rested on the ledge during a break in painting. Side and diagonal grooves extending down the ramp to the well ensure good draining of paint from the ramp, and V-shaped and diagonal ridges on the ramp effect even distribution of paint on the roller.

This application claims priority on U.S. Provisional Application 60/872,491 filed Dec. 4, 2006.

### BACKGROUND OF THE INVENTION

1. Field of the Invention

This invention relates to a paint tray.

2. Description of Related Art

A conventional paint tray includes a well at one end for receiving paint and a ramp, which is usually provided with ribs and grooves for uniform distributing paint on a roller when the latter is rolled up and down the ramp. Cleaning a paint tray can be a messy job, and accordingly liners have become available for paint trays. The liner, which is the same or essentially the same shape as the tray but much thinner is placed in the tray and, once painting has been finished, the liner is discarded or removed from the tray and cleaned for re-use.

More often than not the person doing the painting takes one or more breaks before completing a job. In order to avoid drying of the brushes and rollers, they are often placed in a plastic bag which is quite messy. Alternatively, a roller or brush is left in the paint on the ramp or in the well of the tray. Often the handle of the implement ends up in the paint, i.e. slides or rolls down into the well. Moreover, when a roller is left in a paint tray with the roll in the paint, the roll becomes filled with paint. When the roll is full of paint, splashing and spraying of paint from the roller is the result.

### BRIEF SUMMARY OF THE INVENTION

The present invention provides a solution to the problem of temporary brush and/or roller storage in the form of a tray which ensures that the handle of a brush or roller does not contact paint when being temporarily stored in the tray.

The present invention also provides a tray with an arrangement of ridges and grooves which cause paint to be evenly distributed on a roller, and which cause paint to flow relatively easily into a well at one end of the tray.

In general terms, a tray in accordance with the present invention includes a bottom wall; a pair of opposed side walls and first and second end walls integral with the bottom and side walls; a well defined by one end of the bottom wall, adjacent ends of said side walls and said first end wall for receiving paint; an inclined ramp defined by the remainder of said bottom wall sloping upwardly from said well to the second end wall of the tray; ridges on said ramp for contact by a paint roller during painting; and a ledge proximate an upper end of said first end wall for supporting a handle end of the paint roller or of a brush during storage, whereby the roller or brush bristles are supported by said ramp.

The invention also provides an attachment which can be mounted on the well end of a conventional paint tray to define a ledge having the same function as the ledge described above.

### BRIEF DESCRIPTION OF THE DRAWINGS

The invention is described below in greater detail with reference to the accompanying drawings, which illustrate a preferred embodiment of the invention, and wherein:

FIG. 1 is an isometric view of a paint tray in accordance with the invention;

FIG. 2 is a top view of the paint tray of FIG. 1;

FIG. 3 is an end view of the tray of FIGS. 1 and 2, as seen from the left of FIG. 1;

FIG. 4 is an exploded, side view of the paint tray of FIGS. 1 and 2 in combination with a cover;

FIG. 5 is a longitudinal sectional view of the tray of FIGS. 1 to 4 with a cover thereon;

FIG. 6 is a schematic isometric view of a ledge attachment for a conventional paint tray; and

FIG. 7 is a longitudinal sectional view of one end of a conventional paint tray with the attachment of FIG. 6 mounted thereon.

### DETAILED DESCRIPTION OF THE INVENTION

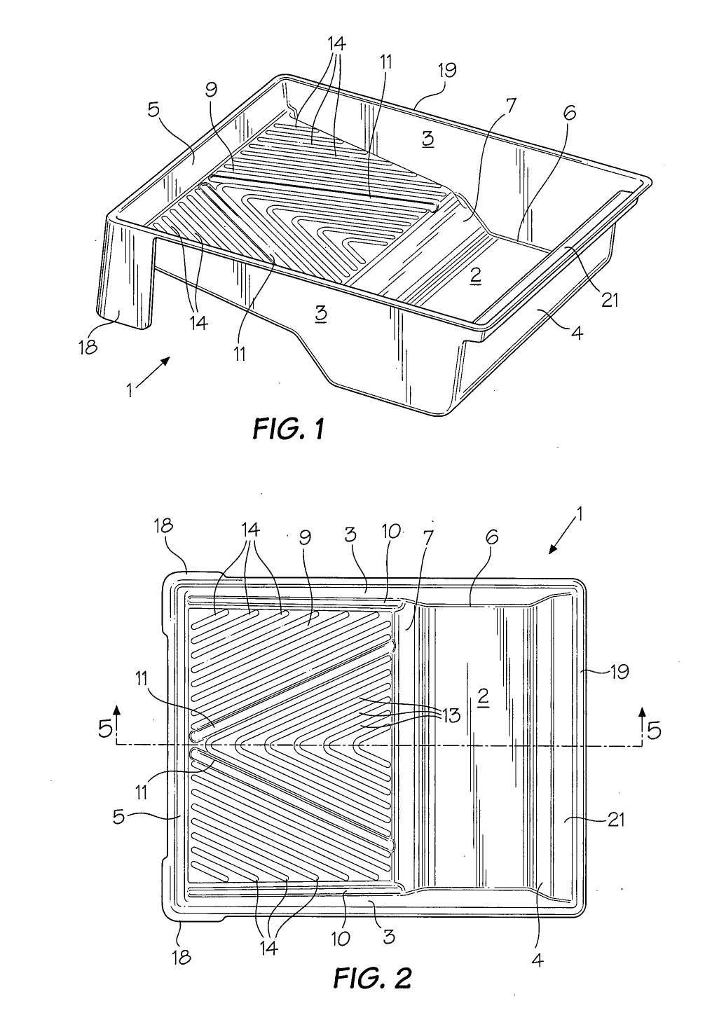

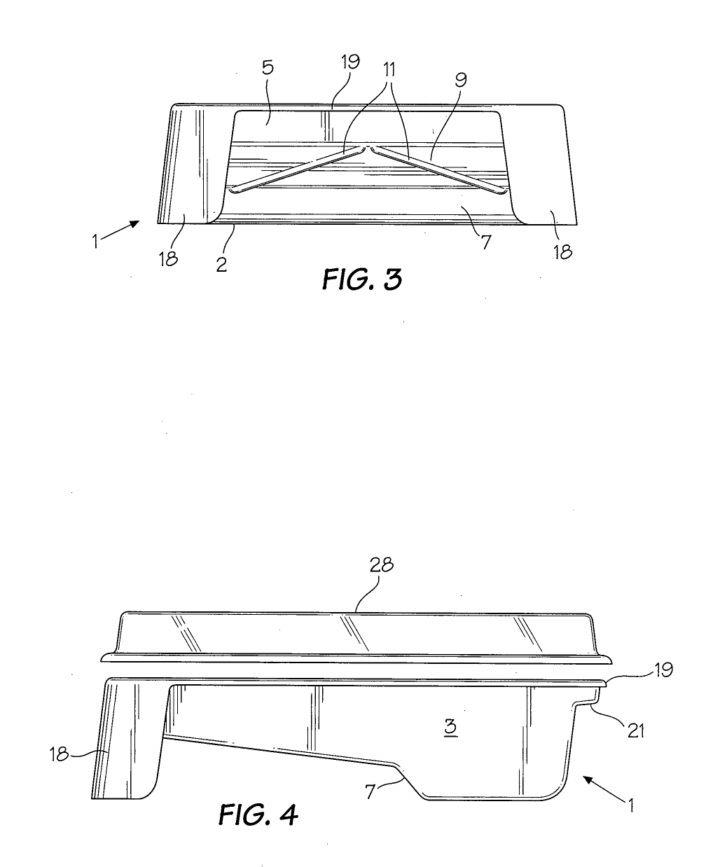

Referring to FIGS. 1 to 3, a tray in accordance with the present invention indicated generally at 1 includes a bottom wall 2, a pair of side walls 3, and end walls 4 and 5 integral with the bottom and side walls 2 and 3, respectively. The bottom wall 2 at one end is planar and defines the bottom of a well 6 for receiving paint (not shown). As in the conventional paint tray, the bottom wall 2 slopes somewhat sharply upwardly toward the other end at a shoulder 7 and then is inclined less steeply to the other end wall 5 to define a ramp 9 with longitudinally extending side grooves 10 (FIG. 2) along each side thereof. A pair of diagonal grooves 11 extend from the center of ramp 9 proximate the end wall 5 to the shoulder 7 close to the side grooves 10. the grooves 10 and 11 drain excess paint from the ramp into the well 6. V-shaped ridges or ribs 13 open towards the well 6 are provided between the grooves 11, and inclined ribs 14 parallel to the grooves 11 extend from proximate the end wall 5 to the side grooves 10. With the ribs 13 and 14 less effort and pressure on the roller are required during painting. Moreover, the ribs 13 and 14 cause paint to flow down the ramp 9 more easily, and paint is evenly spread on a roller in a spiral pattern. Because the tray 1, is shallow at the end wall 5 legs 18 are provided at each side of the tray so that the bottom of the well is horizontal when the tray is resting on a horizontal surface. A flange 19 extends around the periphery of the tray, except in the area of the legs 18.

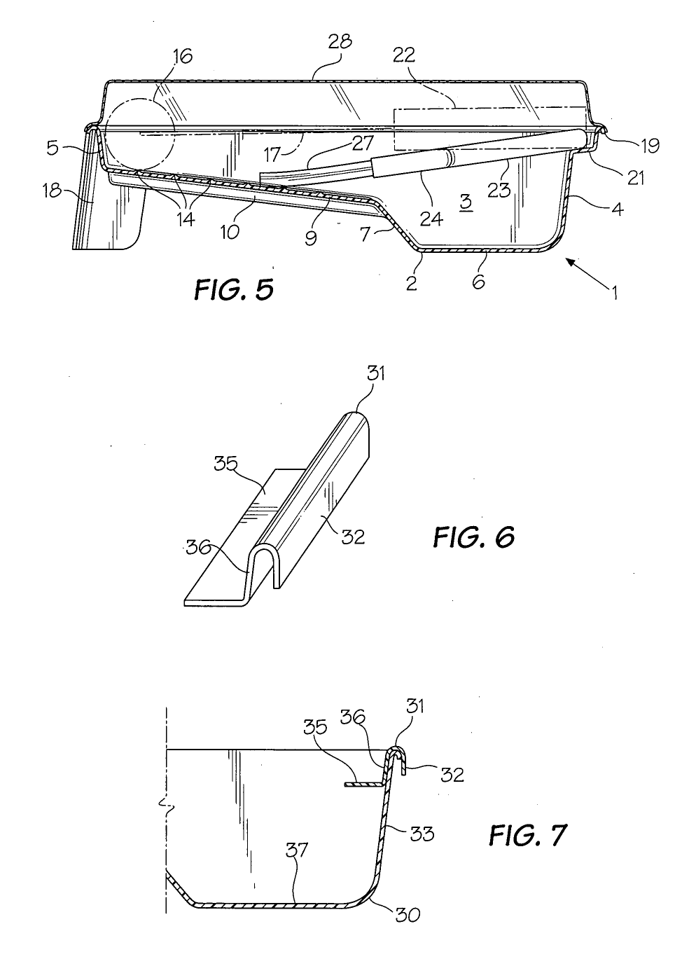

In accordance with the present invention, the end wall 4 is stepped near the top thereof, including a ledge 21. As best shown in FIG. 5, the ledge 21 is designed to support the free ends of the handles 22 and 23 of the roller 17 and a brush 24, respectively. When taking a break from painting, the painter rests the handle 22 of the roller 17 on the ledge 21 with the roll 16 on the upper end of the ramp 9. When the roller 17 is substantially the same length as the tray 1, the roll 16 rests against the end wall 5 at the top end of the ramp 9. The handle 23 of the brush 24 is placed on the ledge 21 so that the bristles 27 rest on the lower end of the ramp 9. As best shown in FIGS. 4 and 5, a cover 28 is placed on the tray 1 to reduce or prevent evaporating of the paint in the tray and to keep the roll 16 and the bristles 27 wet.

It will be appreciated that the unique elements described above including the use of a ledge at one end of a paint tray can be used in any paint tray, i.e. are not restricted to trays having the particular design shown in the drawings.

Referring to FIGS. 6 and 7, a ledge or shelf can be formed on the well end of a conventional paint tray 30 using an attachment 31 in accordance with the present invention. The attachment 31 includes an inverted U-shaped top end 32 for resting on or clipping onto the arcuate top end wall 33 of the paint tray 30. A horizontal shelf or ledge 35 extends outwardly from the bottom of one free end of one leg of the end 32. When the top end 32 of the attachment is placed on the end wall 33 of the tray 30, the ledge 35 extends inwardly over the well 37 of the tray for supporting the handle of a roller and/or a brush. The attachment can be short (3 to 6 inches) or long for extending across substantially the entire width of the tray.

1. A paint tray comprising a bottom wall; a pair of opposed side walls and first and second end walls integral with the bottom and side walls; a well defined by one end of the bottom wall, adjacent ends of said side walls and said first end wall for receiving paint; an inclined ramp defined by the remainder of said bottom wall sloping upwardly from said well to the second end wall of the tray; ridges on said ramp for contact by a paint roller during painting; and a ledge proximate an upper end of said first end wall for supporting a handle end of the paint roller or of a brush during storage, whereby the roller or brush bristles are supported by said ramp.

2. The paint tray of claim 2, wherein said ledge is integral with said first end wall.

3. The paint tray of claim 2, wherein said first end wall includes a step defining said ledge.

4. The paint tray of claim 2, including an attachment defining said ledge, the attachment including an inverted U-shaped top end for mounting on the upper end of said first end wall and a horizontal shelf extending outwardly from a bottom end of one leg of the U-shaped top end.

5. The paint tray of claim 2, including a pair of side grooves in said ramp adjacent to the sides of the tray; and a pair of diagonal grooves in said ramp extending from the center of the ramp adjacent said second end wall to locations proximate said side grooves for draining excess paint from the ramp into the well.

6. The paint tray of claim 5 including a plurality of parallel V-shaped ridges between said diagonal grooves opening towards said well; and a plurality of outer ridges parallel to each said diagonal grooves extending between said second end wall and each of said side grooves for evenly distributing paint on a roller and causing paint to flow smoothly down the ramp.
